(19) United States
(12) Patent Application Publication
(10) Pub. No.: US 2012/0314417 A1
(43) Pub. Date: Dec. 13, 2012

(54) OPTICAL LENS AND LIGHT-EMITTING MODULE USING THE SAME

(75) Inventors: Li-Hung LAI, Hsinchu Hsien (TW); Li-Wen LAI, Hsinchu Hsien (TW); Li-Min HSU, Hsinchu Hsien (TW); Yung-Tai CHEN, Hsinchu Hsien (TW); Shu-Wen CHANG, Hsinchu Hsien (TW)

(73) Assignee: MILLENNIUM COMMUNICATION CO., LTD., Hsinchu Hsien (TW)

(21) Appl. No.: 13/478,267

(22) Filed: May 23, 2012

(30) Foreign Application Priority Data
Jun. 13, 2011 (TW) 100120525

(51) Int. Cl. F21V 5/04

(52) U.S. Cl. 362/255

(57) ABSTRACT

An optical lens for modulating light generated by a surface-emitting laser chip is disclosed. The optical lens includes a main body with a recess. A bottom surface of the recess is configured with a light-entering curved face, and an outer surface of the main body opposite to the bottom surface is configured with a light-existing curved face. Here, the recess is for accommodating the surface-emitting laser chip, and the surface-emitting laser chip is arranged a distance from the light-entering curved face. A light-emitting module adopting the aforementioned optical lens is also provided. The aforementioned optical lens would cause the incident light to first diverge and then converge at a predetermined angle, so that the output illuminating light is more uniform and the projecting distance is extended.

### BACKGROUND OF THE INVENTION

1. Field of the Invention

The present invention relates to an optical element, and more particularly to an optical lens and a light-emitting module including the same.

2. Description of the Prior Art

Due to security and other commercial needs, infrared surveillance systems or recognition systems have been widely used in the field. These systems of prior art mostly use a plurality of light-emitting diodes (LED) with high efficiency as illumination source. However, LED illumination source consumes more power and it is unable to project illumination light at a far position (such as 200˜300 meters), which therefore limits its range of application.

To overcome the abovementioned shortcomings, laser light source has nowadays been adopted as the illumination source in infrared surveillance systems or recognition systems. However, a light pattern of a surface emitting laser is shaped like a donut with a dimmer center area; it easily causes shadow in images so as to decrease recognition accuracy of the system.

Accordingly, it is highly desirable to increase uniformity of an infrared light source and its projection distance.

### SUMMARY OF THE INVENTION

The present invention proposes an optical lens which has a light-entering curved face and a light-exiting curved face. Preferably, the entering-light curved face can be roughened. Therefore, incident light entering to the proposed optical lens from a light source is first diverged and then converged at a predetermined angle, so as to make the illumination light outputted from the proposed light-emitting module with the optical lens more uniform and have a longer projection distance.

In one embodiment of the present invention, the proposed optical lens is for modulating light generated by a surface-emitting laser chip. The proposed optical lens includes a main body with a recess. A bottom surface of the recess has a light-entering curved face and an outer surface of the main body has a light-existing curved face opposite to the bottom surface of the recess, wherein the recess is for accommodating the surface-emitting laser chip, and the surface-emitting laser chip is arranged at a distance from the light-entering curved face.

In another embodiment of the present invention, the proposed light-emitting module comprises an optical lens and at least one surface-emitting laser chip. The optical lens comprises a main body including a recess. A bottom surface of the recess has a light-entering curved face and an outer surface of the main body has a light-existing curved face opposite to the bottom surface of the recess. The surface-emitting laser chip is arranged in the recess and arranged at a distance from the light-entering curved face.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a stereogram schematically illustrating an optical lens according to an embodiment of the present invention;

FIG. 2 is a bottom-view diagram schematically illustrating an optical lens according to an embodiment of the present invention;

FIG. 3 is a cross-sectional diagram along the section line AA in FIG. 2 schematically illustrating the cross-sectional structure of an optical lens according to an embodiment of the present invention; and

FIG. 4 is a cross-sectional diagram schematically illustrating a light-emitting module according to an embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

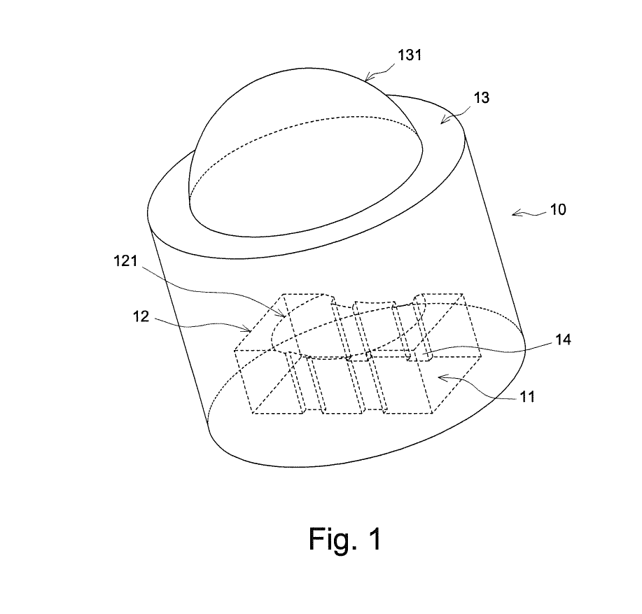

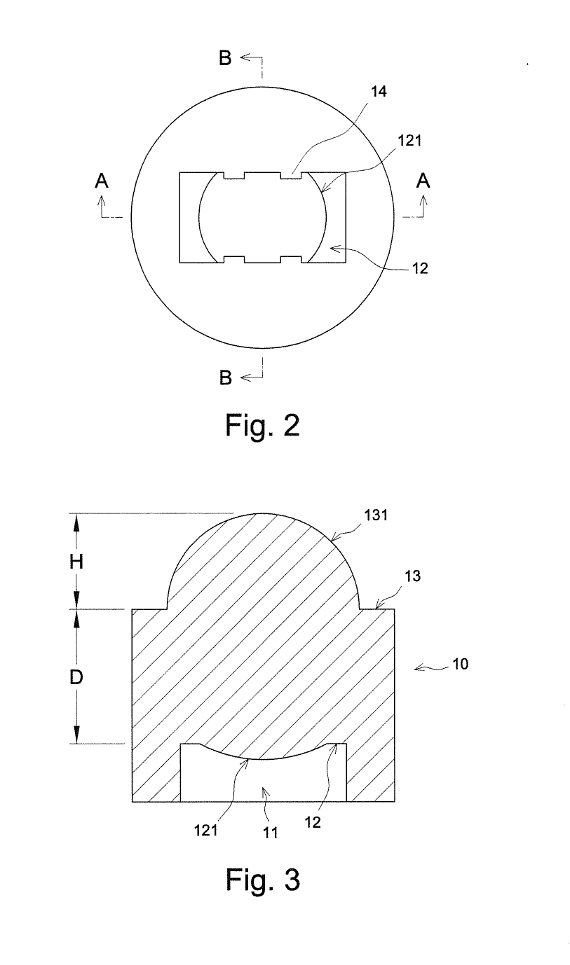

FIG. 1 shows schematically a stereogram of an optical lens according to an embodiment of the present invention. FIG. 2 shows schematically a bottom-view diagram of the proposed optical lens. FIG. 3 shows schematically a cross-sectional structure of the proposed optical lens along the section line AA in FIG. 2. Referring to FIG. 1, FIG. 2 and FIG. 3, the optical lens according to an embodiment of the present invention comprises a main body 10 including a recess 11. A bottom surface 12 of the recess 11 has a light-entering curved face 121. In one embodiment of the present invention, the light-entering curved face 121 is aspheric. In a preferred embodiment of the present invention, the light-entering curved face 121 is treated to be roughened. According to the structure of the optical lens, the light-entering curved face 121 has the effect of diverging the incident light. An outer surface 13 of the main body 10 has a light-existing curved face 131 opposite to the bottom surface 12 of the recess 11. In one embodiment of the present invention, the light-existing curved face 131 is spherical. The light-existing curved face 131 has the effect of converging the divergent light which passes through light-entering curved face 121. Therefore, the illumination light outputted from the optical lens can be converged at a predetermined angle according to need via a designer, thereby improving illumination efficiency.

According to the above-mentioned structure, light rays are generated from the light-emitting element arranged in the recess 11. The light rays first enter the light-entering curved face 121 to be diverged and then enter the light-existing curved face 131 to be converged at the predetermined angle. Therefore, the illumination light outputted from the optical lens of the present invention is more uniform and can be projected at a farther distance.

Referred to FIG. 3, in one embodiment of the present invention, the distance D between the bottom surface 12 of the recess 11 and the outer surface 13 of the main body 10 is greater than protruding height H of the light-exiting curved face 131, for making a greater distance between the light-entering curved face 121 and the light-existing curved face 131, thereby uniformizing the light rays. Referred to FIG. 2, in one embodiment, side walls of the recess 11 have a plurality of opposed protruding parts 14. The plurality of opposed protruding parts 14 can make the optical lens of the present invention be clamped on a substrate. In one embodiment, the main body 10 can be a one piece structure by using glass or polymeric materials, such as acrylic, polycarbonate (PC), or plastic materials etc. It is noted that the main body 10 may be doped with scattering materials to make scattering effects for diverging the incident light.

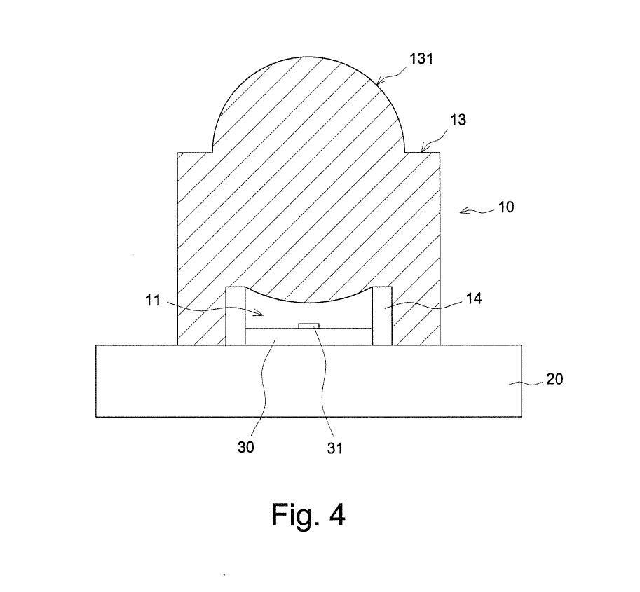

Referred to FIG. 4, a light-emitting module according to an embodiment of the present invention comprises an optical lens and a light-emitting element 31. The optical lens comprises a main body 10. The detailed structure of the main body 10 has been described above and will not be repeated here. The optical lens shown in FIG. 4 illustrates the cross-sectional structure of the optical lens along the section line BB in FIG. 2. The light-emitting element 31 is arranged in the recess 11 and the light-emitting element 31 is arranged at a distance from the light-entering curved face 121. For example, the light-emitting element 31 can be one or a plurality of surface-emitting laser chips arranged on a packaging substrate 30. The plurality of surface-emitting laser chips can be arranged in a linear pattern, array pattern or geometric pattern. After packaging process, the light-emitting element 31 is then arranged on a circuit board 20. As shown in FIG. 4, the main body 10 of the optical lens can utilize opposed protruding parts 14 for abutting against the packaging substrate 30 of the light-emitting element 31, thereby clamping the optical lens and light-emitting element 31 together. It is noted that the optical lens can be also clamped to the circuit board 20 through applicable design, thus the light-emitting element 31 is arranged in the recess 11 of the optical lens

In conclusion, the optical lens of the present invention and the light-emitting module including the same, which comprises a light-entering curved face and a light-existing curved face. Preferably, the light-entering curved face can be roughened to improve scattering effect. Therefore, incident light from a light source entering to the optical lens of the present invention first passes through the light-entering curved face to be diverged and then converged by light-exiting curved face at a predetermined angle so as to make the illumination light which passes the optical lens of the present invention to be more uniform and to be projected at a farther distance.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An optical lens, for modulating light generated by a surface-emitting laser chip, comprising:
a main body including a recess, a bottom surface of the recess has a light-entering curved face and an outer surface of the main body has a light-existing curved face opposite to the bottom surface of the recess, wherein the recess is for accommodating the surface-emitting laser chip, and the surface-emitting laser chip is arranged at a distance from the light-entering curved face.

2. The optical lens according to claim 1, wherein the light-entering curved face is roughened.

3. The optical lens according to claim 1, wherein the light-entering curved face is aspheric.

4. The optical lens according to claim 1, wherein the light-exiting curved face is spherical.

5. The optical lens according to claim 1, wherein the distance between the bottom surface of the recess and the outer surface of the main body is greater than protruding height of the light-exiting curved face.

6. The optical lens according to claim 1, wherein side walls of the recess have a plurality of opposed protruding parts for clamping the optical lens on a substrate.

7. The optical lens according to claim 1, wherein the main body is a one piece structure.

8. The optical lens according to claim 1, wherein the material of the main body is doped with scattering materials.

9. The optical lens according to claim 1, wherein the material of the main body is glass or polymer

10. A light-emitting module, comprising:
an optical lens which comprises a main body including a recess, a bottom surface of the recess has a light-entering curved face and an outer surface of the main body has a light-existing curved face opposite to the bottom surface of the recess; and
at least one surface-emitting laser chip arranged in the recess and arranged at a distance from the light-entering curved face.

11. The light-emitting module according to claim 10, wherein light-entering curved face is roughened.

12. The light-emitting module according to claim 10, wherein light-entering curved face is aspheric.

13. The light-emitting module according to claim 10, wherein the light-exiting curved face is spherical.

14. The light-emitting module according to claim 10, wherein the distance between the bottom surface of the recess and the outer surface of the main body is greater than protruding height of the light-exiting curved face.

15. The light-emitting module according to claim 10, wherein side walls of the recess have a plurality of opposed protruding parts for clamping the light-emitting module on a substrate.

16. The light-emitting module according to claim 10, wherein the optical lens is a one piece structure.

17. The light-emitting module according to claim 10, wherein the material of the optical lens is doped with scattering materials.

18. The light-emitting module according to claim 10, wherein the material of the optical lens is glass or polymer.

19. The light-emitting module according to claim 10, wherein the plurality of surface-emitting laser chips are arranged in a linear pattern, array pattern, or geometric pattern.
